(19) United States
(12) Patent Application Publication
(10) Pub. No.: US 2017/0289359 A1
(43) Pub. Date: Oct. 5, 2017

(54) MULTITENANT VIDEO INTERCOM DOOR STATION

(71) Applicant: Bird Home Automation GmbH, Berlin (DE)

(72) Inventors: Sascha Keller, Berlin (DE); Bernd Müller, Kleinmachnow (DE)

(21) Appl. No.: 15/478,836

(22) Filed: Apr. 4, 2017

Related U.S. Application Data
(60) Provisional application No. 62/317,768, filed on Apr. 4, 2016.

(51) Int. Cl. H04M 11/02; H04L 29/08; H04M 3/42; H04M 1/2745; H04M 1/02; H04M 1/725

(52) U.S. Cl. CPC H04M 11/025; H04M 1/0291; H04M 1/7253; H04M 3/42068; H04M 1/274508; H04M 1/274516; H04L 67/025; H04M 3/42221; H04M 2201/50

(57) ABSTRACT

A wireless, multitenant video intercom door station is provided, along with methods for operating same. A common door station may be installed near a property entry door. The common door station may be utilized to select a desired tenant, and identify one or more tenant door stations and/or tenant personal electronic devices associated with the desired tenant. Notifications may be transmitted to the tenant door stations and/or devices. A tenant may respond to the notification to initiate a video intercom session. Communications may be routed through a cloud server for recording of communication content and/or activity logging.

### TECHNICAL FIELD

The present disclosure relates to the field of door stations. More specifically, this disclosure relates to video intercom door stations utilizing wireless data interconnects in multitenant installations.

### BACKGROUND

Individuals increasingly seek convenience and safety across many aspects of their lives. In line with those priorities, door answering stations are becoming increasingly popular. A number of systems have arisen for providing people with means for convenient, secure two-way communications with visitors at their door, without requiring occupants to travel to and/or open their door.

As door stations become increasingly expected or desired, multitenant facilities may wish to implement door station solutions for their tenants. However, traditional multitenant door station installations can be very costly. Equipment costs can include a common exterior door station as well as indoor station equipment for each tenant. Retrofitting that equipment can also be extremely complex, costly and time consuming. Many structures do not have sufficient or appropriate cabling in place to interconnect the common external door station with individual tenant stations. If cabling is in place, it may not be appropriate for modern audiovisual communications technologies, or the wiring may be in poor condition.

Even if the cost of equipment and installation is feasible, the tenants' portions of the door station system may be installed at fixed locations within a property. Even if the location is relatively central within the property, users may still be inconvenienced by having to move to the location of the tenant door station in order to communicate with individuals at the common door station.

As such, it may be desirable to provide a low-cost, easy installation video door intercom system for multitenant installations.

### SUMMARY

A multitenant video intercom door station, and methods for operating same, are provided. A common door station can be installed in a common location, such as near an entry door of a multitenant facility. Tenant door stations can be installed locally within each tenant's premises. Additionally or alternatively, tenant personal electronic devices may be utilized as tenant stations for communication with the common door station. The common door station and tenant door station (and/or personal electronic devices) communicate via a wireless data communications link, preferably an IEEE 802.11-based connection implementing one or a set of media access control (MAC) and physical (PHY) layer specifications, thereby enabling installation with minimal wiring requirements.

Visitors can utilize the common door station to ring a selected tenant. One or more devices, such as tenant door stations and/or personal electronic devices, may be associated with the selected tenant, and notified of the visitor. A responding tenant can utilize to initiate a video intercom connection using a tenant door station or tenant personal electronic device, and communicate with the visitor. Tenant personal electronic devices may also be utilized to configure system settings via a cloud server. The cloud server can optionally record video and audio content via an AV recording module, for remote access by a tenant as security footage and/or visitor auditing.

The common door station may also be utilized to initiate predetermined actions in response to alternative visitor interactions, such as presentation of an RFID tag or NFC-enabled or Bluetooth-enabled device, presentation of a QR-code or bar-code, or facial recognition.

These and other aspects of the embodiments will become apparent in light of the disclosure elsewhere herein.

### BRIEF DESCRIPTION OF THE FIGURES

FIG. 1 is a schematic representation of a computing environment implementing a multitenant video intercom door station system.

FIG. 2 is a schematic representation of a computing environment implementing a multitenant video intercom door station system.

FIG. 3 is a schematic block diagram of a common door station.

FIG. 4 is a front perspective view of a common door station.

FIG. 5 is a schematic block diagram of a tenant door station.

FIG. 6 is a schematic block diagram of a cloud server.

FIG. 7 is a process flow chart for using a multitenant video intercom door station system.

### DESCRIPTION OF THE PREFERRED EMBODIMENTS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

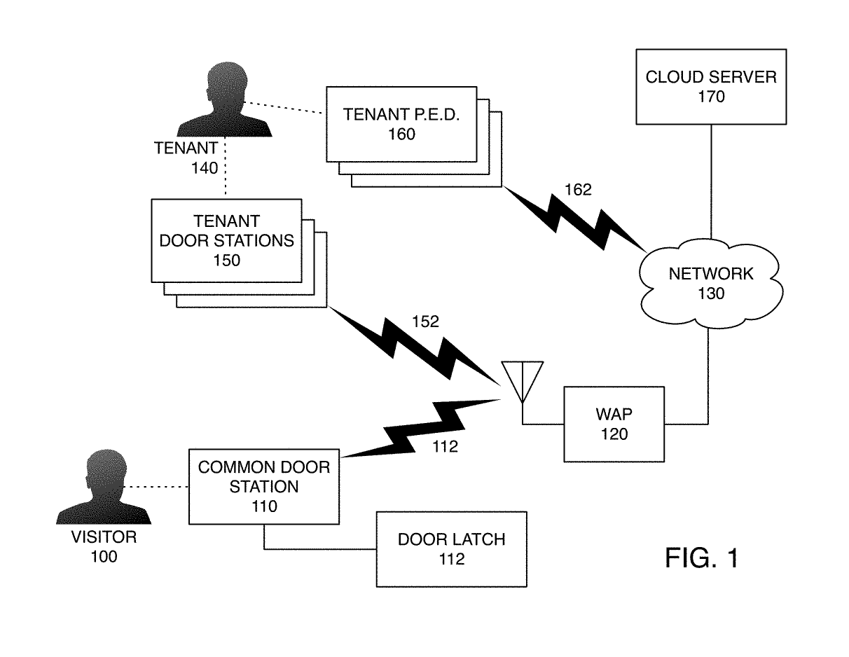

A multitenant video intercom door station system can be implemented with reduced equipment and/or installation costs. FIG. 1 is a schematic representation of a computing environment in which such a multitenant video intercom door station system can be implemented. Common door station 110 is typically installed in a common area of a multitenant property, where common door station 110 will be accessible to visitors 100. Common door station 110 is typically installed near a structure entry door. An electronic door latch 112 may be installed within an entry door lock mechanism to facilitate remote, electronic release of the door. Common door station 110 implements wireless packet-based data networking link 112 with wireless access point (“WAP”) 120. WAP 120 interconnects with data network 130, which preferably includes the Internet.

WAP 120 also communicates via wireless data network link 152 with tenant portions of the door station system, i.e. tenant door stations 150. In many installations, one or more tenant door stations 150 (described further below) will be installed locally within a tenant's private space (e.g. apartment or office). Tenant door stations 150 are thereby accessible to a tenant 140 while the tenant resides in their associated private space.

Wireless networking links 112 and 152 enable data communications between common door station 110 and tenant door stations 150, without requiring installation of cabling runs between the area of the common door station and various tenant spaces. In some embodiments, wireless networking links 112 and 152 will each be implemented using IEEE 802.11 wireless networking specifications, with one or a set of media access control (MAC) and physical layer (PHY) specifications, to enable communications between common door station 110 and tenant door stations 150. Indeed, by using wireless IP networking, any kind of data may be exchanged amongst common door station 110, tenant door stations 150 and tenant personal electronic devices 160 (described further below).

While illustrated in FIG. 1 with wireless networking links to a common WAP, it is contemplated and understood that network links 112 and 152 may be implemented, in whole or in part, using one or more wired networking links. For example, in large installations, it may be desirable to install multiple WAPs throughout a facility, the WAPs being interconnected with wired data network links and each communicating wirelessly with different tenant door stations.

The system of FIG. 1 also includes tenant personal electronic devices (“PEDs”) 160. Tenant PEDs 160 may include, without limitation, smartphones, tablet computers, laptop computers, desktop computers, smart glasses, smart watches, smart appliances and other mobile or installed electronic devices featuring microprocessors, user interface mechanisms and networked data communications capabilities. Tenant PEDs 160 communicate via data network connection 162 (which may be wired and/or wireless) to network 130. Typically, in operation, a PED 160 will execute an application (such as a mobile app) downloaded and installed on PED 160 to implement the communications, user interactions and other functionality described elsewhere herein.

In some embodiments, the system may also include cloud server 170, capable of communicating via network 130 with one or more of common door station 110, tenant door stations 150 and tenant personal electronic devices 160.

In some embodiments, tenant PEDs 160 are optional, with tenant communications taking place entirely via tenant door stations 150. In other embodiments, tenant door stations 150 are optional; in such use cases, tenant communications can take place entirely via tenant personal electronic devices 160. With the proliferation of smartphones and other PEDs, some installations may assume the availability of tenant PEDs to minimize equipment costs, such that multitenant door station systems can be implemented with only common door station 110 and cloud server 170, thereby significantly reducing costs for equipment, installation and maintenance in a multi-tenant property.

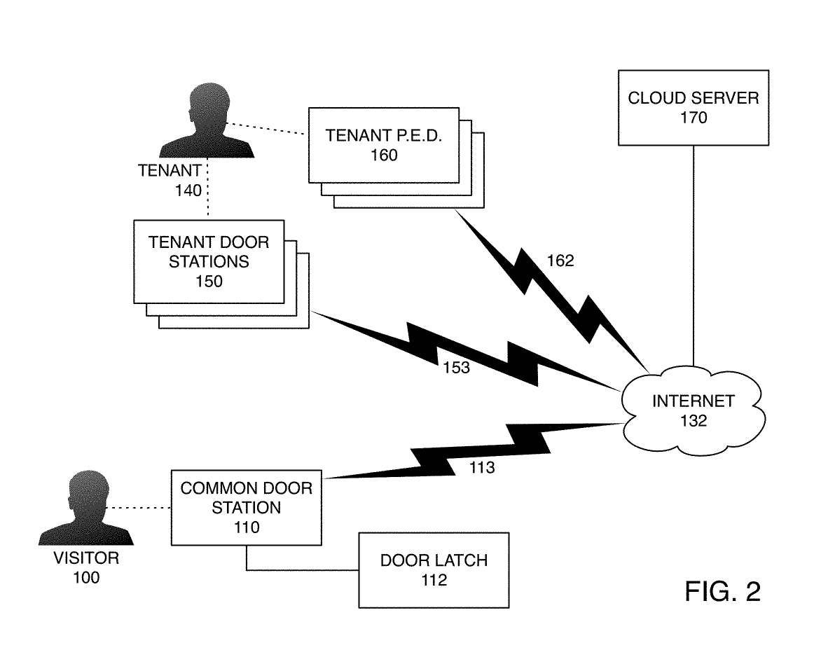

In the preferred embodiment of FIG. 1, at least common door station 110 and tenant door stations 150 communicate via a common local area packet network (“LAN”) which may also be a wireless local area packet network (“WLAN”). By implementing stations 110 and 150 on a common LAN, door station functionality can be maintained, even in the event of an interruption in Internet or wide area network services. However, it is contemplated and understood that in other embodiments, common door station 110 and one or more of tenant door stations 150 may, in fact, be on different LANs. FIG. 2 illustrates one such alternative implementation, in which stations 110 and 150 each communicate over Internet 132, via Internet connections 113 and 153.

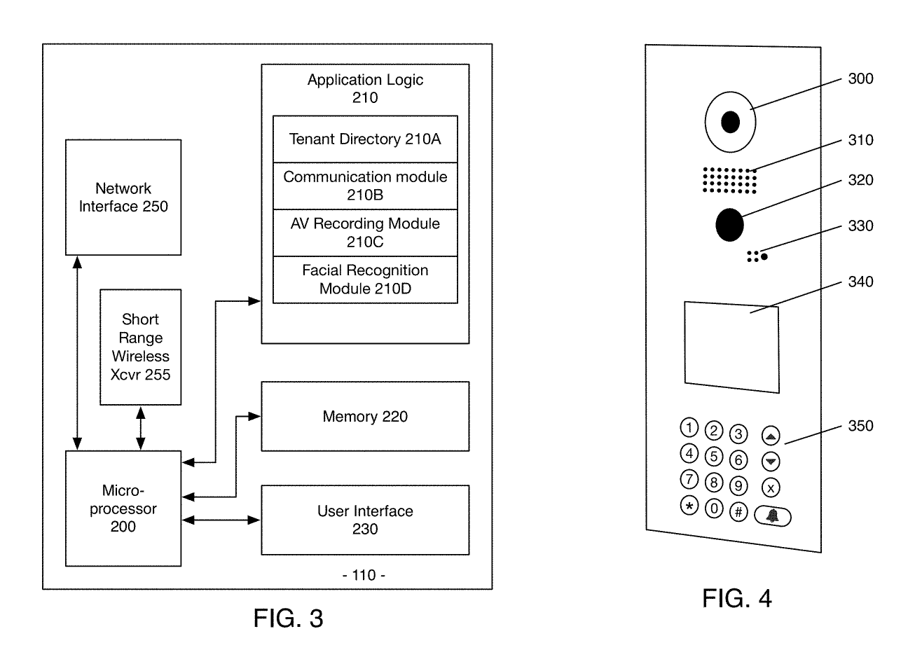

FIG. 3 is a schematic block diagram of common door station 110, in an exemplary embodiment. Common door station 110 includes microprocessor-based controller 200 executing application logic 210 and accessing digital memory 220 to perform various functions described elsewhere herein. Common door station 110 also includes user interface 230, and network interface 250. FIG. 4 is a perspective front view of common door station 110, illustrating components of user interface 230. User interface 230 includes video camera 300, speaker 310, light 320, microphone 330, display screen 340 and keypad 350. Microprocessor 200 implements application logic 210 to interact with user interface 230 and perform various functions described further elsewhere herein.

While the embodiment of FIG. 3 implements a visual user interface including display screen 340 and keypad 350, it is contemplated and understood that alternative embodiments may include different mechanisms for interacting with users, including, without limitation, embodiments omitting a display screen altogether. For example, in some applications (such as highly cost-sensitive applications or applications in which a common door station is exposed to extreme environmental conditions), it may be desirable to implement a common door station user interface that substitutes a physical button array in lieu of the display screen/keypad combination, where each individual button is labeled for a particular tenant, apartment number or office, and depression of the assigned button causes common door station 110 to ring the associated tenant (as described further hereinbelow).

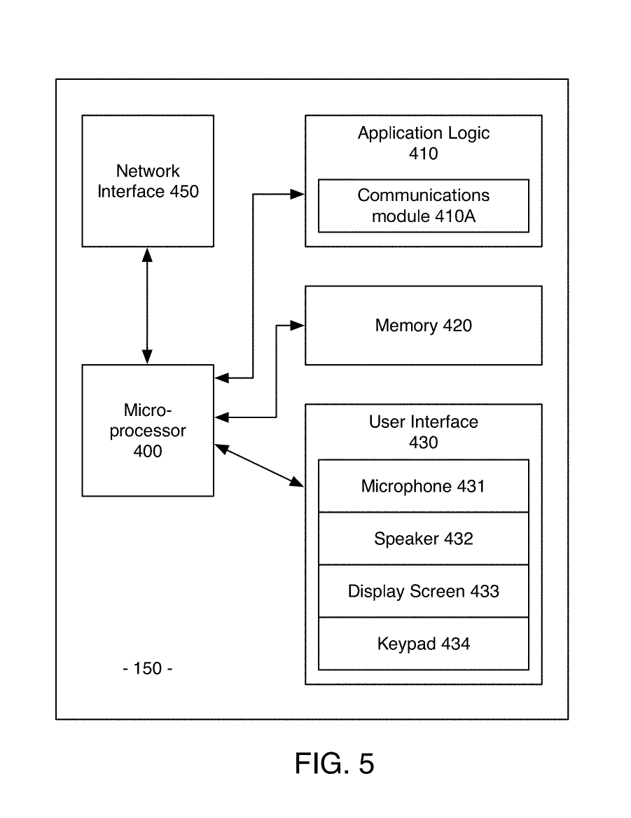

FIG. 5 is a schematic block diagram of tenant door station 150. Tenant door station 150 includes microprocessor 400 executing application logic 410 and accessing memory 420 to perform the various functions described elsewhere herein. User interface 430 provides a mechanism for tenants to interact with tenant door station 150, and includes microphone 431, speaker 432, display screen 433 and keypad 434, analogous to like components in common door station 110. Tenant door station 150 implements network interface 450 to enable communications via data communications link 152.

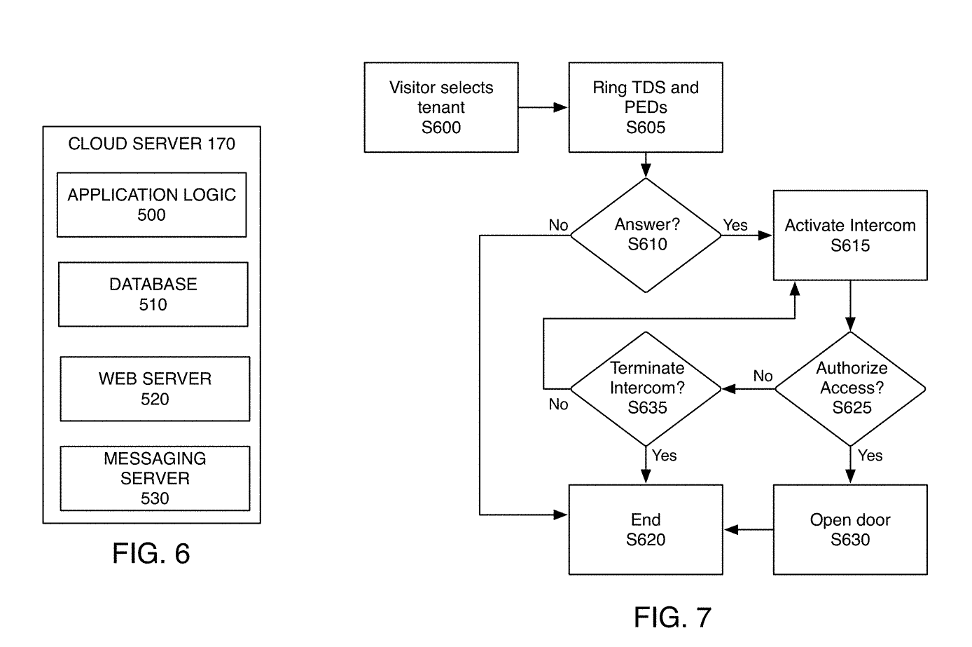

FIG. 6 is a schematic block diagram of cloud server 170. Server 170 implements application logic 500, and operates to store information within, and retrieve information from, database 510. The term “database” is used herein broadly to refer to an indexed store of data, whether structured or not, including without limitation relational databases and document databases. Web server 520 hosts one or more Internet web sites and web services enabling outside user interaction with, amongst other things, application logic 500 and database 510. Messaging server 530 enables messaging, such as push notifications to mobile or desktop applications, cellular network messaging services (e.g. SMS or MMS), and/or email, between server 170 and other devices, such as tenant PEDs 160, tenant door stations 150 and/or common door station 110.

While depicted in the schematic block diagram of FIG. 6 as a block element with particular sub elements, as known in the art of modern web applications and network services, server 170 may be implemented in a variety of ways, including via distributed hardware and software resources and using any of multiple different software stacks. Server 170 may include a variety of physical, functional and/or logical components such as one or more each of web servers, application servers, database servers, email servers, SMS, push notification servers or other messaging servers, and the like. That said, the implementation of server 170 will include, at some level, one or more physical servers, at least one of the physical servers having one or more microprocessors and digital memory for, inter alia, storing instructions which, when executed by the processor, cause the server to perform methods and operations described herein.

FIG. 7 illustrates an exemplary process that may be implemented via the equipment of FIG. 1. In step S600, visitor 100 approaches common door station 110, and selects a tenant using user interface 230. For example, in the embodiment of FIG. 4, application logic 210 (particularly, tenant directory component 210A) operating on microprocessor 200 will utilize display screen 340 to implement a visual user interface. The visual user interface will preferably include display of instructions for use, and indicia enabling navigation of a tenant directory using keypad 350. Visitor 100 thereby selects a tenant for contacting using keypad 350 and display screen 340. In other embodiments or applications, alternative mechanisms and user interfaces may be used for selecting tenants in step S600, such as pressing an individual button assigned to a particular tenant.

In step S605, common door station 110 (under continuing operation of tenant directory component 210A) identifies one or more of tenant door stations 150 and/or tenant PEDs 160 associated with the tenant that was selected in step S600, and triggers a communication module 210B within application logic 210 to ring the tenant-associated devices. In some embodiments, tenants within the directory made available by tenant directory component 210A are associated with device network addresses in a device directory that is stored locally within common door station memory 220. In other embodiments, a directory of tenant/device associations may be hosted remotely, such as by cloud server 170, and queried as needed by common door station 110 to identify tenant-associated devices. In yet other embodiments, a centralized directory may be hosted within a database by cloud server 170, but synchronized (e.g. periodically or in response to an update notification) with directory information cached locally within common door station 110; such a local/remote synchronization mechanism may facilitate easy and location-independent system configuration, while still permitting at least partial operation of door station 110 in the event wide area network communications are interrupted.

Common door station 110 may ring the tenant-associated devices in one or more different ways. In some circumstances, common door station 110 may implement network-based signaling directed specifically to the tenant-associated device (and application logic implemented thereon, such as communications module 410A), with the receiving device application logic generating ring indicia, such as emitting a sound (e.g. via speaker 432) and/or generating a visual ring indicium (e.g. on display screen 433). In other circumstances, it may be desirable to utilize alternative signaling protocols. For example, if a tenant-associated device is a smartphone, signaling may occur via a third party service provider's application notification platform. Preferably, tenant PEDs 160 receive ring signaling and interact with common door station 110 without regard to the location of the tenant PED, as long as network connectivity is available. Therefore, a tenant can receive notification of, and interact with, door station visitors, even while traveling or otherwise away from the property location.

In step S610, a determination is made as to whether a tenant-associated device being rung in step S605 is answered. If not, the interaction ends (step S620). If so, an intercom connection is initiated between common door station 110 and the answered tenant-associated device, via an IP-based data network connection (step S615). The intercom connection may begin with ring notifications to appropriate tenant devices, which may be answered. In some embodiments, a notification may include emitting a ringing sound at the tenant devices, providing a visual notification (e.g. flashing light and/or display screen message) or haptic feedback. In some embodiments, notification may be accompanied by one-way transmission of video and/or audio content from common door station 110 to alerted tenant devices. In some embodiments, notifications may be answered (e.g. via pressing a device button or selecting a soft key implemented on a graphical user interface) to initiate two-way communications.

In an exemplary embodiment in which tenant door station 150 is answered, visitor sound and imagery is captured by common door station camera 300 and microphone 330, and streamed in substantially real time to tenant door station 150 via network connection 112, AP 120 and network connection 152. Application logic 410, including communications module 410A, operates to display video imagery on display screen 433 and emit audio signaling via speaker 432, respectively. Conversely, tenant audio signals received by microphone 431 within tenant door station 150, are streamed via network connection 152, AP 120 and network connection 112 to door station 110 and reproduced by speaker 310 under the control of application logic 210. Meanwhile, if camera 300 detects low light levels at door station 110, LED light 320 may be illuminated to improve the visibility of visitor 100 to tenant 140. While this example contemplates a tenant receiving both audio and video signals, and a visitor receiving only audio, it is contemplated and understood that in other embodiments, two-way video may be provided, e.g. the tenant-associated device may include a camera, streaming video signals to display screen 340.

In another exemplary embodiment, a tenant may respond via tenant PED 160, such as a smartphone. In such a case, in step S600, common door station 110 may access a directory within memory 220 to determine that a tenant PED 160 is associated with the selected tenant. In step S605, common door station 110 may then transmit a ring request to cloud server 170. Cloud server 170 then triggers a ring notification via a smartphone service provider's mobile application notification service, which in turn triggers a notification to tenant PED 160 (e.g. ringing and/or a visual indication of incoming intercom request from common door station 110). In step S610, tenant 140 may then answer the request, or ignore it, using user interface components provided on tenant PED 160 (e.g. selectable soft keys rendered on a touchscreen graphical user interface). If answered, an intercom connection is initiated in step S615, e.g. streaming video and/or audio signals are routed between common door station 110, cloud server 170 and tenant PED 160. In some embodiments, audio, video and other intercom signaling between common door station 110 and tenant door stations 150 may be transmitted through (or in parallel to) cloud server 170, even without involvement of tenant PEDs 160, thereby enabling, e.g., cloud storage of communications and event logging.

Continuing in step S615, tenant 140 may communicate in real time with visitor 100. In some circumstances, tenant 140 may determine whether to authorize premises access for visitor 100 (step S625), and if so, a common entry door (not shown) may be released via electronic door latch 112 installed within the common entry door lock (step S630). Otherwise, tenant 140 and/or visitor 100 will evaluate in step S635 whether to terminate the intercom connection (step S620) or continue communicating (step S615).

Because tenant-device associations are software-based and network-implemented, significant flexibility can be provided. For example, in some embodiments, multiple tenant PEDs may be associated with a given tenant. Thus, if multiple individuals share an apartment, each resident's smartphone and/or computer can be rung in response to visitors. If the system is utilized in an office environment, multiple individuals may be contacted simultaneously or in series (analogous to a telephone system call tree). Time and other criteria may also be utilized to provide conditional device notifications. Moreover, cloud server 170 may implement a web application accessible from tenant PEDs 160 in order to easily configure tenant-device associations and notification criteria.

Through the system of FIG. 1 and/or 2, and the process of FIG. 7, users may be able to implement a multi-tenant video intercom system with minimal wiring or premises retrofitting, and using tenant personal electronic devices in addition to, or in lieu of, dedicated tenant door station equipment.

In some embodiments, additional or alternative visitor interactions may be supported. For example, common door station 110 may implement a short range wireless transceiver 255, such as a Bluetooth transceiver and/or NFC transceiver, via which microprocessor 200 can interact with RFID tags, Bluetooth-enabled devices and/or NFC-enabled devices (such as a visitor's smartphone, smart watch, electronic key fob or other mobile electronic device) placed proximate door station 110 by visitor 100, in order to exchange an identifying indicium such as an RFID tag UUID, Bluetooth address, MAC address or the like. Application logic 210 may operate to look up the identifying device indicium within a data store of associations between device indicium and associated system response instructions (which data store may be hosted, e.g., within memory 220 for local query, or within network-accessible database 510 for query via network 130 or 132). Common door station 110, server 170 or other components can then automatically take action in response to detection of known RFID tags or Bluetooth or NFC communications, such as automatically ringing a predetermined tenant associated with the detected visitor mobile electronic device, automatically releasing electronic door latch 112 to open the common entry door, or both.

In another example, application logic 210 may implement a bar-code and/or QR-code reader utilizing imagery from camera 300, such that placement of a bar or QR code within the field of view of camera 300 by visitor 100 can trigger a predetermined action, analogous to the short range wireless-triggered mechanisms described above (e.g. ringing a particular tenant and/or automatically releasing an electronic door latch). Configuration of such visitor interactions and automatic responses thereto can be configured via a web portal implemented on cloud server 170 and web server 520, and accessed by tenant PEDs 160.

In accordance with another aspect of operation, cloud server 170 can be utilized to automatically update firmware or other software or data stores resident locally on common door station 110. For example, common door station 110 may periodically poll cloud server 170 to determine the availability of new software updates and, if available, download them via network 130.

In accordance with another aspect, video and/or audio signals exchanged between common door station 110 and tenant-associated devices may be recorded. In some embodiments, all audio and video signals to and from common door station 110 will be recorded locally in memory 220 by an AV recording module 210C implemented by application logic 210. Recorded audio and video signals may include two-way communications during step S615; in some embodiments, recordings may be initiated immediately upon ringing of a tenant in step S605, thereby providing a visual and audible record of visitors, even when a tenant misses the visitor or otherwise does not answer. Such recordings can be used for security and monitoring purposes. In other embodiments, audio-video signals to and from common door station 110 are communicated to or through cloud server 170 (preferably securely, such as via VPN or encrypted data stream). Cloud server 170 then implements an AV recording module within application logic 500 and maintains the recordings within database 510. Recordings associated with a particular tenant can then be made available to the tenant via a web-based portal implemented by web server 520, thereby providing a security record and visitor audit trail. In addition to audio-video recordings, cloud server 170 may also maintain a detailed event log within database 510, so that tenants can access a time and date-stamped record of visitor interactions and missed visitors.

In accordance with another aspect, facial recognition functionality may be implemented using video and/or images captured by camera 300. Specifically, digital imagery captured by camera 300 can be conveyed to a facial recognition module implemented via common door station application logic 210 (module 210D) and/or cloud server application logic 500. In response to recognition of a visitor's face, predetermined actions can be initiated, such as release of a common door electronic latch 112 and/or notification of a predetermined tenant 140. Specification of facial data and associated actions can be configured via web server 520, accessed by tenant PEDs 160.

The previous description of the disclosed embodiments is provided to enable any person skilled in the art to make or use the invention disclosed herein. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. All references cited herein are expressly incorporated by reference.

1. A method for alerting a selected tenant to a visitor's presence in a multitenant property, the method comprising:
interacting with a common door station, by the visitor, to identify a selected tenant from amongst a plurality of tenants associated with a multitenant property;
searching within a directory to identify one or more tenant devices associated with the selected tenant; and
initiating a wireless intercom connection between the common door station and an answering tenant device from amongst the one or more tenant devices associated with the selected tenant.

2. The method of claim 1, in which the step of interacting with a common door station, by a visitor, to identify a selected tenant comprises selecting an indicium associated with the selected tenant using a visual user interface implemented by the common door station.

3. The method of claim 1, in which the step of interacting with a common door station, by a visitor, to identify a selected tenant, comprises:
placing a visitor mobile electronic device proximate the common door station to wirelessly exchange a visitor device indicium between the mobile electronic device and a short range wireless transceiver within the common door station; and
searching within a device data store comprising associations between visitor device indicia and predetermined action response instructions in order to initiate an action associated with the visitor device indicium.

4. The method of claim 3, in which the step of searching within a device data store comprises querying a data store maintained locally within the common door station.

5. The method of claim 3, in which the step of searching within a device data store comprises querying a remote network-connected data store.

6. The method of claim 1, in which the step of searching within a directory to identify one or more tenant devices associated with the selected tenant comprises searching within a directory maintained locally by the common door station.

7. The method of claim 1, in which the step of searching within a directory to identify one or more tenant devices associated with the selected tenant comprises querying a remote database hosted by a network-connected server.

8. The method of claim 1, in which the step of searching within a directory to identify one or more tenant devices associated with the selected tenant comprises searching within a directory maintained locally by the common door station and synchronized with a remote database hosted by a network-connected server.

9. The method of claim 1, in which the step of initiating an intercom connection between the common door station and an answering tenant device from amongst the one or more tenant devices associated with the selected tenant, comprises:
transmitting ring notifications to the one or more tenant devices; and
upon answering a notification by an answering tenant device, streaming video and audio signals between the common door station and the answering tenant device.

10. The method of claim 1, in which the tenant devices comprise of tenant-owned mobile personal electronic devices.

11. The method of claim 1, in which the tenant devices consist of tenant-owned mobile personal electronic devices.

12. A door station apparatus for use in a multitenant property comprising:
a common door station for installation proximate an entry door in a multitenant property, comprising a microprocessor-based controller, a wireless network interface and user interface components, the user interface components comprising a camera, microphone and speaker;
a plurality of tenant door stations, the tenant door stations comprising wireless network interfaces and communicating with the common door station via a wireless packet-based data communications link, each tenant door station further comprising a display screen, speaker and microphone; and
application logic implemented by the common door station, the application logic comprising:
a tenant directory component enabling selection of a tenant from amongst a plurality of tenants using one or more of the common door station user interface components; and
a communications mechanism to route video signals from the common door station camera to a display screen associated with a selected tenant door station via a wireless communication link.

13. The door station apparatus of claim 12, further comprising:
one or more tenant personal electronic devices, each tenant personal electronic device being associated with a tenant by the tenant directory component and capable of intercom communications with the common door station, whereby video and audio signals can be routed between the common door station and a selected tenant personal electronic device in response to selection of the associated tenant by a common door station user.

14. The door station apparatus of claim 13, further comprising a cloud server, the cloud server comprising a web server capable of interaction with one or more of the tenant personal electronic devices in order to configure common door station functionality.

15. The door station apparatus of claim 14, in which the cloud server further comprises:
an AV recording component to store audio and video content received from the common door station, a tenant door station and/or a tenant personal electronic device; and
a web server providing a remotely accessible user interface to access audio and video content stored by the AV recording module.

16. The door station apparatus of claim 12, in which the tenant directory component comprises a tenant device database stored locally within the common door station.

17. The door station apparatus of claim 12, in which the tenant directory component comprises application logic configured to query a remote, network-connected tenant device database.

18. The door station apparatus of claim 12, further comprising a short range wireless communication transceiver for interaction with a visitor personal electronic device to ring a predetermined tenant.

19. The door station apparatus of claim 12, further comprising a short range wireless communication transceiver for interaction with a visitor personal electronic device to electronically release an entry door.
